(19) United States
(12) Patent Application Publication
(10) Pub. No.: US 2026/0255205 A1
(43) Pub. Date: Aug. 27, 2026

(54) SIGNALING BETWEEN COMMUNICATION NODES TO CREATE OR REFINE A DIGITAL TWIN

(71) Applicant: QUALCOMM Incorporated, San Diego, CA (US)

(72) Inventors: Parag Mohan KANADE, San Diego, CA (US); Sony AKKARAKARAN, Poway, CA (US); Lokesh JAIN, San Diego, CA (US); Satyam GABA, San Diego, CA (US)

(21) Appl. No.: 19/411,039

(22) Filed: Dec. 5, 2025

Related U.S. Application Data
(60) Provisional application No. 63/763,752, filed on Feb. 26, 2025.

(51) Int. Cl. H04W 24/10; H04B 17/309; H04B 17/391; H04W 24/02

(52) U.S. Cl. CPC H04W 24/10; H04B 17/309; H04B 17/3913; H04W 24/02

(57) ABSTRACT

Methods, systems, and devices for wireless communication are described. Various aspects relate to techniques according to which a digital twin may be refined based on signaling between a server associated with the digital twin and one or more communication nodes within a geographic area associated with the digital twin. Some aspects more specifically relate to signaling mechanisms according to which the server may request one or more other communication nodes to report network data that the server may use to refine the digital twin. The server may send a request to a first communication node, which may provide network coverage to the geographic area, to obtain network data from one or more other communication nodes. The one or more communication nodes may respond with the requested network data and, in accordance with receiving the requested network data, the first communication node may send the received network data to the server.

### CROSS REFERENCE

The present Application for Patent claims benefit of U.S. Provisional Patent Application No. 63/763,752 by Kanade et al., entitled “SIGNALING BETWEEN COMMUNICATION NODES TO CREATE OR REFINE A DIGITAL TWIN,” filed Feb. 26, 2025, assigned to the assignee hereof, and expressly incorporated by reference in its entirety.

### FIELD OF TECHNOLOGY

The following relates to wireless communication, including signaling between communication nodes to create or refine a digital twin.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a first communication node is described. The method may include transmitting, to a second communication node located within a geographic area associated with a digital twin, a request for network data, receiving, from the second communication node, the network data in accordance with the request, and sending, to a server associated with the digital twin, the network data received from the second communication node.

A first communication node for wireless communication is described. The first communication node may include one or more memories storing processor executable code, and one or more processors coupled with the one or more memories. The one or more processors may individually or collectively be operable to execute the code to cause the first communication node to transmit, to a second communication node located within a geographic area associated with a digital twin, a request for network data, receive, from the second communication node, the network data in accordance with the request, and send, to a server associated with the digital twin, the network data received from the second communication node.

Another first communication node for wireless communication is described. The first communication node may include means for transmitting, to a second communication node located within a geographic area associated with a digital twin, a request for network data, means for receiving, from the second communication node, the network data in accordance with the request, and means for sending, to a server associated with the digital twin, the network data received from the second communication node.

A non-transitory computer-readable medium storing code for wireless communication is described. The code may include instructions executable by one or more processors to transmit, to a second communication node located within a geographic area associated with a digital twin, a request for network data, receive, from the second communication node, the network data in accordance with the request, and send, to a server associated with the digital twin, the network data received from the second communication node.

Some examples of the method, first communication nodes, and non-transitory computer-readable medium described herein may further include operations, features, means, or instructions for obtaining, from the server associated with the digital twin, an indication of a type of one or more channel quality measurements requested from one or more communication nodes or of a condition associated with the digital twin, where the request for the network data may be transmitted in accordance with the indication.

In some examples of the method, first communication nodes, and non-transitory computer-readable medium described herein, the network data includes one or more channel quality measurements by the second communication node or meta data associated with the second communication node.

In some examples of the method, first communication nodes, and non-transitory computer-readable medium described herein, the request for the network data may be transmitted in accordance with a condition associated with the digital twin being satisfied by the second communication node and the condition associated with the digital twin may be satisfied based on one or more of a location of the second communication node being within a target area within the geographic area, a modem type of the second communication node, an original equipment manufacturer of the second communication node, or an actual channel quality measurement by the second communication node differing by at least a threshold amount relative to an expected channel quality measurement associated with the digital twin.

Some examples of the method, first communication nodes, and non-transitory computer-readable medium described herein may further include operations, features, means, or instructions for transmitting, to a third communication node located within the geographic area associated with the digital twin, a second request for second network data, receiving, from the third communication node, the second network data in accordance with the second request, and sending, to the server associated with the digital twin, the second network data received from the third communication node.

Some examples of the method, first communication nodes, and non-transitory computer-readable medium described herein may further include operations, features, means, or instructions for packaging the network data received from the second communication node and the second network data received from the third communication node within one or more messages, where the network data and the second network data may be sent to the server via the one or more messages.

In some examples of the method, first communication nodes, and non-transitory computer-readable medium described herein, the second request for the second network data may be transmitted in accordance with a condition associated with the digital twin being satisfied by the third communication node.

A method for digital twin refinement by a server associated with a digital twin (e.g., a digital twin server, which may be or include a digital twin creation entity) is described. The method may include sending, to a first communication node that provides network coverage for a geographic area associated with the digital twin, a request for network data from one or more other communication nodes within the geographic area and obtaining, from the first communication node, the network data in accordance with the request.

A server associated with a digital twin for digital twin refinement is described. The server associated with a digital twin may include one or more memories storing processor executable code, and one or more processors coupled with the one or more memories. The one or more processors may individually or collectively be operable to execute the code to cause the server associated with a digital twin to send, to a first communication node that provides network coverage for a geographic area associated with the digital twin, a request for network data from one or more other communication nodes within the geographic area and obtain, from the first communication node, the network data in accordance with the request.

Another server associated with a digital twin for digital twin refinement is described. The server associated with a digital twin may include means for sending, to a first communication node that provides network coverage for a geographic area associated with the digital twin, a request for network data from one or more other communication nodes within the geographic area and means for obtaining, from the first communication node, the network data in accordance with the request.

A non-transitory computer-readable medium storing code for digital twin refinement is described. The code may include instructions executable by one or more processors to send, to a first communication node that provides network coverage for a geographic area associated with the digital twin, a request for network data from one or more other communication nodes within the geographic area and obtain, from the first communication node, the network data in accordance with the request.

Some examples of the method, server associated with a digital twins, and non-transitory computer-readable medium described herein may further include operations, features, means, or instructions for using the network data to create or refine the digital twin in accordance with reception of the network data from the first communication node.

In some examples of the method, server associated with a digital twins, and non-transitory computer-readable medium described herein, the network data includes a respective set of one or more channel quality measurements by each communication node of the one or more other communication nodes or respective meta data associated with each communication node of the one or more other communication nodes.

In some examples of the method, server associated with a digital twins, and non-transitory computer-readable medium described herein, the request for the network data indicates a type of one or more channel quality measurements requested from the one or more other communication nodes or indicates a condition associated with the digital twin.

In some examples of the method, server associated with a digital twins, and non-transitory computer-readable medium described herein, the request for the network data may be sent in accordance with a condition associated with the digital twin being satisfied by the one or more other communication nodes and the condition associated with the digital twin may be based on one or more of a target area within the geographic area, a modem type, an original equipment manufacturer, or a threshold difference relative to an expected channel quality measurement associated with the digital twin.

A method for wireless communication by a first communication node is described. The method may include receiving, from a second communication node, a request for network data in accordance with a digital twin being associated with a geographic area within which the first communication node is located and transmitting, to the second communication node, the network data in accordance with the request.

A first communication node for wireless communication is described. The first communication node may include one or more memories storing processor executable code, and one or more processors coupled with the one or more memories. The one or more processors may individually or collectively be operable to execute the code to cause the first communication node to receive, from a second communication node, a request for network data in accordance with a digital twin being associated with a geographic area within which the first communication node is located and transmit, to the second communication node, the network data in accordance with the request.

Another first communication node for wireless communication is described. The first communication node may include means for receiving, from a second communication node, a request for network data in accordance with a digital twin being associated with a geographic area within which the first communication node is located and means for transmitting, to the second communication node, the network data in accordance with the request.

A non-transitory computer-readable medium storing code for wireless communication is described. The code may include instructions executable by one or more processors to receive, from a second communication node, a request for network data in accordance with a digital twin being associated with a geographic area within which the first communication node is located and transmit, to the second communication node, the network data in accordance with the request.

In some examples of the method, first communication nodes, and non-transitory computer-readable medium described herein, the network data includes one or more channel quality measurements by the first communication node or meta data associated with the first communication node.

Some examples of the method, first communication nodes, and non-transitory computer-readable medium described herein may further include operations, features, means, or instructions for performing the one or more channel quality measurements in accordance with reception of the request and determining the meta data in accordance with performance of the one or more channel quality measurements.

In some examples of the method, first communication nodes, and non-transitory computer-readable medium described herein, the request for the network data may be received in accordance with a condition associated with the digital twin being satisfied by the first communication node and the condition associated with the digital twin may be satisfied based on one or more of a location of the first communication node being within a target area within the geographic area, a modem type of the first communication node, an original equipment manufacturer of the first communication node, or an actual channel quality measurement by the first communication node differing by at least a threshold amount relative to an expected channel quality measurement associated with the digital twin.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports signaling between communication nodes to create or refine a digital twin in accordance with one or more aspects of the present disclosure.

FIG. 2 shows an example of a signaling diagram that supports signaling between communication nodes to create or refine a digital twin in accordance with one or more aspects of the present disclosure.

FIGS. 3 and 4 show block diagrams of devices that support signaling between communication nodes to create or refine a digital twin in accordance with one or more aspects of the present disclosure.

FIG. 5 shows a block diagram of a communications manager that supports signaling between communication nodes to create or refine a digital twin in accordance with one or more aspects of the present disclosure.

FIG. 6 shows a diagram of a system including a UE that supports signaling between communication nodes to create or refine a digital twin in accordance with one or more aspects of the present disclosure.

FIG. 7 shows a diagram of a system including a network entity that supports signaling between communication nodes to create or refine a digital twin in accordance with one or more aspects of the present disclosure.

FIGS. 8 through 10 show flowcharts illustrating methods that support signaling between communication nodes to create or refine a digital twin in accordance with one or more aspects of the present disclosure.

### DETAILED DESCRIPTION

Some network operators, controllers, providers, or planners/developers may create and use a digital twin associated with a geographic area to help make decisions, predictions, or estimations associated with a wireless communications system located within the geographic area. As described herein, a geographic area may include an indoor area (e.g., inside a building or structure), an outdoor area, or any combination of one or more indoor areas and one or more outdoor areas. For example, a digital twin associated with a geographic area may enable interested parties to use digital models to (at least approximately) replicate one or more devices, objects, processes, or conditions of the geographic area (or of the wireless communications system) and perform simulations within a virtual representation of the geographic area. In other words, a digital twin associated with a geographic area may be referred to or understood as a virtual environment or a virtual representation of the geographic area and may be used to perform one or more of various simulations. Such simulations performed using the digital twin may provide insight into how devices, objects, processes, or conditions of a real-world version of the geographic area interact or perform, among other examples. For example, a digital twin associated with a geographic area may be used to simulate, predict, or estimate one or more metrics associated with wireless communications within the geographic area. A digital twin creation entity may generate, create, construct, or otherwise output a digital twin. Such a digital twin creation entity may be included within a server or may be or include one or more servers, one or more processing systems, one or more devices, or any combination thereof, any of which may be collocated or non-collocated. A digital twin creation entity may generate a digital twin based on original input data and may update the digital twin over time.

One or more of various techniques may be used to generate a digital twin, such as lidar-based techniques, radar-based techniques, or depth camera-based techniques. Generating a digital twin according to such techniques may involve a significant amount of manual labor and, accordingly, may lack scalability to some geographic areas. Some other techniques, such as those associated with using data associated with a three-dimensional model of a geographic area (e.g., obtained from a third-party vendor), may be relatively more scalable to a wide range of geographic areas. In some cases, however, a three-dimensional model of a geographic area may have imperfections, such as “holes” due to occlusion. For example, three-dimensional models of some geographic areas may be generated using images taken from one or more aerial devices (e.g., a satellite, a drone, or a low-flying airplane, one or more of which may perform aerial imagery), which may be unable to acquire images of an area underneath an overhang, a canopy, a bridge, a tree grove, or any other surface or object that obstructs a view of another surface or object. A digital twin that is generated using a three-dimensional model with imperfections may be an inaccurate representation of the actual geographic area at locations associated with the imperfections, which may result in inaccurate simulations (e.g., such that simulation results using the digital twin are dissimilar to actual measurements within a real-world version of the geographic area). Thus, digital twin creation and refinement techniques that are both scalable and accurate may be desirable.

Various aspects generally relate to techniques according to which a digital twin may be created and refined based on signaling between a server associated with the digital twin (e.g., a digital twin creation entity) and one or more communication nodes within a geographic area associated with the digital twin. Some aspects more specifically relate to signaling mechanisms according to which the server associated with the digital twin, which may be referred to herein as a digital twin server, may request one or more other communication nodes to measure and report one or more metrics that the server may use to create, update, or refine the digital twin. In some examples, the server may send a request to a first communication node to obtain network data from one or more other communication nodes. In such examples, the first communication node may provide network coverage (e.g., via one or more Uu links and/or one or more sidelinks) to a geographic area associated with the digital twin. The network data may include one or more channel quality measurements, meta data, or both. The request by the server may indicate one or more requested types of channel quality measurements and, in some implementations, a condition associated with from which communication nodes the first communication node is to request the network data. Such a condition may be a criterion for selecting one or more communication nodes from which to request the network data. In accordance with receiving the request from the server, the first communication node may transmit, to one or more communication nodes (that satisfy the condition), a request for the network data. The one or more communication nodes may respond with the requested network data and, in accordance with receiving the requested network data, the first communication node may send the received network data to the server (which may use the network data to generate, create, construct, update, refine, or otherwise output the digital twin).

Aspects of the subject matter described in this disclosure can be implemented to realize one or more of the following potential advantages. For example, by acquiring network data from communication nodes within the geographic area associated with the digital twin (that satisfy a condition), the server (e.g., the digital twin creation entity) may create or refine the digital twin based on actual measurements performed by one or more select communication nodes within the geographic area. Such creation or refinement based on actual measurements performed by one or more select communication nodes may result in a more accurate digital twin (e.g., a digital twin that is more representative of the actual geographic area) while controlling signaling overhead between communication nodes. For example, the server may set the condition such that network data is requested (e.g., only requested) from communication nodes within a target area for which a three-dimensional model has a “hole” due to an occlusion. In such examples, the server may use the requested network data to generate a more accurate representation of the geographic area at the target area, which may lead to more accurate simulation results using the digital twin with relatively low signaling overhead. Further, in accordance with the digital twin providing more accurate simulation results, the digital twin may be used to make better decisions, predictions, or estimations associated with wireless communications within the geographic area, which may facilitate greater system capacity, higher data rates, and greater spectral efficiency, among other benefits.

Aspects of the disclosure are initially described in the context of wireless communications systems. Additionally, aspects of the disclosure are illustrated by and described with reference to a signaling diagram. Aspects of the disclosure are further illustrated by and described with reference to apparatus diagrams, system diagrams, and flowcharts that relate to signaling between communication nodes to create or refine a digital twin.

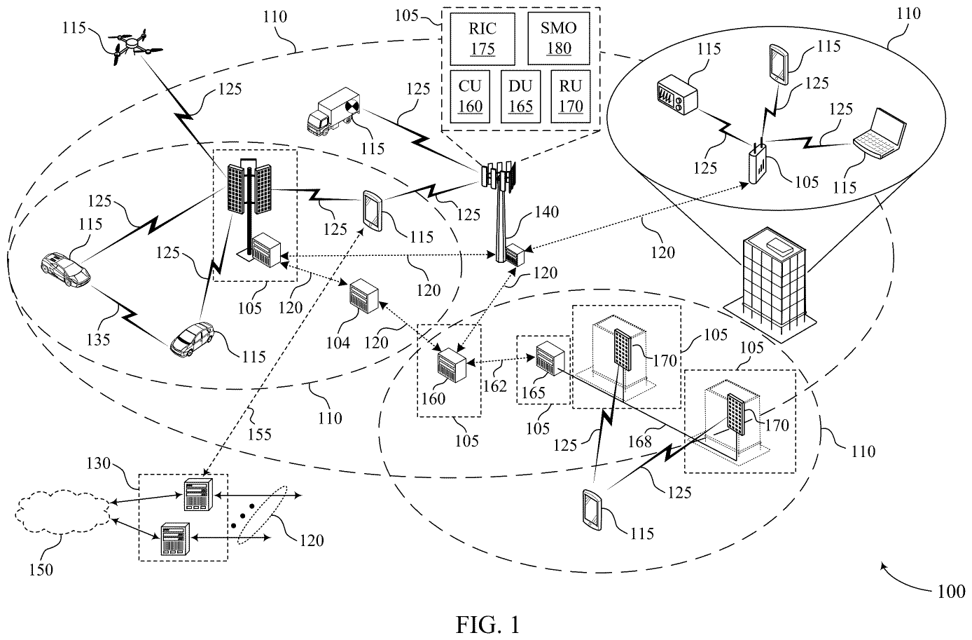

FIG. 1 shows an example of a wireless communications system 100 that supports signaling between communication nodes to create or refine a digital twin in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some implementations, a communication node may include or incorporate capabilities of network functions or entities that may not directly transmit wireless signals but coordinate with or control transmitting entities. For example, a communication node may include a location management function (LMF), a network data analytics function (NWDAF), or one or more other network functions that may be physically co-located with a transmitting entity (such as a gNB or other network entity 105) or may be physically separate from but communicatively coupled with a transmitting entity. In such cases in which a network function is physically separate from a transmitting entity, the communication node may be understood to encompass both the network function and the transmitting entity that it coordinates with or controls for the purpose of wireless transmission. Thus, when a communication node that includes a non-transmitting network function is described as transmitting information, it may do so by incorporating the transmission capabilities of an associated transmitting entity.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support signaling between communication nodes to create or refine a digital twin as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be located within a geographic area and, in some cases, a network operator, controller, provider, or planner/developer may create and use a digital twin associated with the geographic area to help make decisions, predictions, or estimations associated with the wireless communications system 100. The network operator, controller, provider, or planner/developer may use the digital twin to model a physical environment in a virtual environment (e.g., a virtual world) and, instead of or in addition to performing measurements or tests within the physical environment, may perform measurements or tests using the model of the physical environment. In other words, a digital twin may be a model of a real-world environment in a virtual world. A digital twin may run any quantity of simulations to study one or multiple processes. A digital twin may have access to near real-time data, such that digital twins may be designed around a two-way flow of information including real-world sensors/measurements (input to a digital twin creation entity) and simulation results (output from the digital twin creation entity).

A digital twin creation entity may generate a digital twin based on a three-dimensional model of a geographic area. Using wireless raytracing and/or artificial intelligence (AI)-based techniques (e.g., AI-based wireless simulation), one or more transmitters and one or more receivers may be placed within the three-dimensional model and RF paths between the one or more transmitters and the one or more receivers may be raytraced to generate data, with such data being usable to perform studies to predict, estimate, or otherwise determine one or more metrics associated with wireless communications within the geographic area. A network operator, controller, provider, or planner/developer may use such data and/or metrics to make decisions associated with a real-world version of the wireless communications system 100, as such data and/or metrics may approximate actual data and/or metrics that might have been obtained if measurements or tests within the physical environment were performed. In other words, a digital twin associated with a geographic area including the wireless communications system 100 may leverage or otherwise involve wireless raytracing to simulate or emulate a performance of the wireless communications system 100.

In some implementations, one or more communication devices, nodes, or entities of the wireless communications system 100 may support techniques according to which a digital twin may be created and refined based on signaling between a server associated with the digital twin (e.g., a digital twin creation entity) and one or more communication nodes within a geographic area associated with the digital twin. For example, one or more communication devices, nodes, or entities of the wireless communications system 100 may generate a digital twin associated with a geographic area within which the wireless communications system 100 is located. In such implementations, the server associated with the digital twin, which may be referred to herein as a digital twin server or a digital twin creation entity, may request one or more other communication nodes to measure and report one or more metrics that the server may apply to the digital twin (e.g., to create, update, or refine the digital twin). The server may be located at or within a network entity 105, a UE 115, or any other node or device associated with the wireless communications system 100. In other words, the server may be collocated with a network entity 105, a UE 115, or any other node or device associated with the wireless communications system 100. Additionally, or alternatively, the server may be non-collocated with a network entity 105, a UE 115, or any other node or device associated with the wireless communications system 100. In other words, the serve (e.g., a digital twin creation entity) may be understood as being within a single device or node or distributed across multiple devices or nodes. The server may be located at or within the core network 130.

In some examples, the server may send a request to a first communication node to obtain network data from one or more other communication nodes. In such examples, the first communication node may provide network coverage (e.g., via one or more Uu links and/or one or more sidelinks) to a geographic area associated with the digital twin. The network data may include one or more channel quality measurements, meta data, or both. The request by the server may indicate one or more requested types of channel quality measurements or a condition associated with from which communication nodes the first communication node is to request the network data, or both. Such a condition may be a criterion for selecting one or more communication nodes from which to request the network data. In accordance with receiving the request from the server, the first communication node may transmit, to one or more communication nodes that satisfy the condition, a request for the network data. The one or more communication nodes may respond with the requested network data and, in accordance with receiving the requested network data, the first communication node may send the received network data to the server (which may use the network data to create or refine the digital twin). The first communication node may be a network entity 105, a UE 115, or any other device or node (e.g., an LMF or an NWDAF) associated with the wireless communications system 100. The one or more communication nodes from which the first communication node requests network data may be one or more network entities 105, one or more UEs 115, one or more other devices or nodes associated with the wireless communications system 100, or any combination thereof.

Further, in some implementations, a communication node may transmit network data to another communication node or the server unconditionally (e.g., without a satisfaction of a condition). In such implementations, the server may indicate a condition or may not indicate a condition associated with acquisition of the network data and, regardless of whether a condition is indicated, may receive network data from one or more communication nodes regardless of whether a condition (if indicated) is satisfied. For example, one or more communication nodes may autonomously determine when to provide network data to the server or may periodically provide network data to the server (e.g., in accordance with a periodic reporting configuration), among other examples. In accordance with supporting unconditional network data provision to the server, the wireless communications system 100 may provide greater flexibility associated with digital twin creation or refinement (e.g., with fewer constraints), which may result in a digital twin that is more accurately representative of the geographic area.

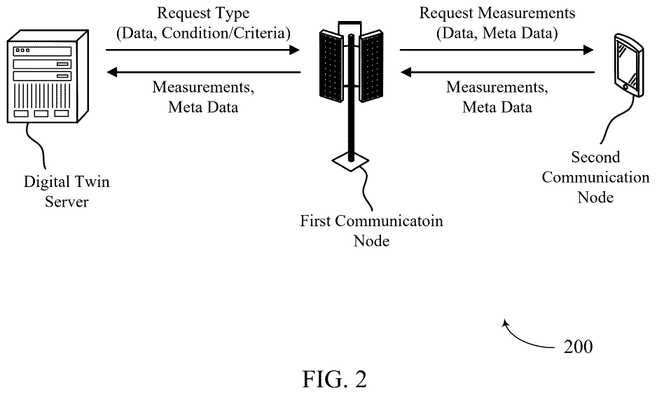

FIG. 2 shows an example of a signaling diagram 200 that supports signaling between communication nodes to create or refine a digital twin in accordance with one or more aspects of the present disclosure. In accordance with the signaling diagram 200, a digital twin server (and/or a digital twin creation entity, which may be located within the digital twin server or otherwise communicatively coupled with the digital twin server) may communicate with one or more communication nodes within a geographic area to obtain network data associated with the geographic area. The digital twin server may use the obtained network data to create, generate, construct, update, refine, or otherwise output a digital twin.

In some scenarios, wireless data generated from a digital twin may be different than a real-life measurement. Such differences between data generated from a digital twin and data obtained from a real-life measurement may be understood as a simulation-to-real (Sim2Real) gap. Such scenarios may arise for one or more of various reasons, including “holes” within a three-dimensional model of a geographic area (due to, for example, occlusion). Thus, some systems may benefit from mechanisms according to which a digital twin may be updated or refined based on real-life measurements. Accordingly, in some implementations of the present disclosure, one or more devices or nodes may support messaging/signaling to enable creation and refining of a digital twin.

In some implementations, an entity creating the digital twin (which may be or include a gNB, a UE 115, a network entity 105, an LMF, an NWDAF, a “Digital Twin Server,” or any other device, node, entity, or functionality described herein) may request one or more other nodes (e.g., one or more network entities 105 (such as one or more gNBs) or one or more UEs 115, or any combination thereof) to measure and report one or more specific metrics. The entity creating the digital twin may request such one or more specific metrics to create or refine a digital twin model, such as by filling in “holes” present within a three-dimensional model of a geographic area based on which the digital twin is generated. The digital twin creation entity may detect that a communication node (e.g., a network entity 105 or a UE 115) is at a location where the digital twin model could use refinement. A location where the digital twin model could use refinement, or a location of the communication node, may be determined in accordance with one or more of various positioning techniques, such as time difference of arrival (TDoA), angle of departure (AoD), or angle of arrival (AoA). A communication node may be requested to send RF data and, in some implementations, meta data associated with one or more measurements (and/or meta data associated with the communication node). Such mechanisms may be applied to retrieve or obtain data from various types of communication nodes, including one or more components of one or more network entities 105, one or more UEs 115, or any combination thereof.

The digital twin creation entity may create, update, or refine the digital twin based on real-life measurements obtained from one or more communication nodes. For example, digital twin-based wireless data generation may be different than real-life measurements, and the real-life measurements may be used to increase an accuracy of the digital twin based on wireless data generation. Such techniques may be referred to or understood as a closed loop digital twin. Two or more of various communication nodes may support a signaling mechanism to support such a closed loop digital twin, which may involve first signaling from the digital twin server to a first communication node (e.g., a gNB, an LMF, an NWDAF, a network entity 105, or a UE 115), second signaling from the first communication node to a second communication node (e.g., a network entity 105 or a UE 115, among other example nodes), third signaling from the second communication node to the first communication node, and fourth signaling from the first communication node to the digital twin server. Alternatively, the signaling mechanism may involve the first signaling and the second signaling (without additional signaling between the first communication node and the second communication node).

The digital twin server may request data from one or multiple communication nodes (such as a gNB, an LMF, an NWDAF, a network entity 105, or a UE 115) via the first signaling. For example, the digital twin server may transmit a request type message that indicates a requested data and a condition (e.g., at least one criterion) associated with the requested data. The digital twin server may indicate a requested type of measurements from one or more communication nodes. For example, the digital twin server may indicate a request for one or more reference signal receive power (RSRP) measurements or a request for one or more signal-to-interference-plus-noise ratio (SINR) measurements, or both, among other RF measurements in some implementations. Such measurements may be referred to herein as one or more channel quality measurements. Additionally, or alternatively, the digital twin server may indicate criteria for selecting one or more communication nodes from which the requested measurements are to be received. Such criteria for selecting the one or more communication nodes may include or be based on a location of a communication node, a modem type of a communication node, an original equipment manufacturer (OEM) of a communication node, differences between a simulated channel measurement and an actual channel measurement (e.g., at a specific location, by at least a threshold amount, etc.), or any combination thereof. Additionally, or alternatively, such criteria for selecting the one or more communication nodes may include or be based on a data throughput, a data type (e.g., file transfer protocol (FTP), video call, extended reality (XR), gaming, etc.), a presence of sensors (the sensors can be built in the communication node, such as a camera in the device, or can be external, such as radar or lidar mounted in a different communication node), a time of day (e.g., as data may differ based on the time because, for example, different times may be associated with different network loadings), a network loading, a mobility characteristic or mobility state of a communication node (e.g., stationary, walking, slow-moving, fast-moving, in-vehicle, etc.), or a congestion level, among other examples.

Additionally, or alternatively, the digital twin server may indicate a request for meta data. The requested meta data may include information indicative of a state (e.g., mobility) of a communication node (e.g., stationary, walking, running, in-vehicle, etc.), one or more pictures taken by the communication node (e.g., from one or multiple sources, such as an always-on camera, a front-facing camera, or a rear-facing camera), information indicative of whether a communication node is indoor or outdoor, or sensor data associated with a communication node (e.g., an orientation of the communication node, a humidity measured or otherwise known by the communication node, a pressure measured or otherwise known by the communication node, etc.). In some implementations, a communication node may acquire meta data from or via an external sensor, such as a radar or lidar mounted on another communication node (e.g., a gNB), among other examples. For example, a gNB may request one or more measurements from a UE 115 and/or meta data associated with the UE 115, may supplement the information received from the UE 115 with meta data associated with the UE 115 that the gNB acquires (e.g., from or via a radar or lidar mounted on the gNB), and may send the information received from the UE 115 and the supplemented gNB-acquired meta data to the digital twin server. One or more measurements, meta data, or both may be collectively referred to herein as network data. The digital twin server may transmit the request to the first communication node via wired (e.g., in accordance with a USB, such as USB-C, signaling protocol or any other wired signaling protocol) or wireless signaling (e.g., in accordance with a 3GPP signaling protocol, an 802.11 signaling protocol, or any other wireless signaling protocol).

The first communication node may transmit a request for network data from the second communication node via the second signaling. For example, the first communication node may transmit one or more messages that requests one or more measurements from the second communication node and, in some examples, additionally requests meta data associated with the one or more measurements or associated with the second communication node. The first communication node may transmit the request for the network data from the second communication node in association with receiving the first signaling from the digital twin server. In some implementations, the first communication node may determine that the second communication node satisfies the condition indicated by the digital twin server and may create (and transmit) one or more messages to request the network data from the second communication node in accordance with the second communication node satisfying the condition. By way of example, using positioning techniques, the first communication node may determine a set of one or more communication nodes that satisfy the condition set by the digital twin server and may request network data from each communication node of the set of one or more communication nodes that satisfy the condition. The first communication node may transmit the request for network data to the second communication node (or, by way of example, to a set of one or more other communication nodes) via one or more messages associated with a 3GPP signaling protocol, an 802.11 signaling protocol, or any other wireless signaling protocol. By way of example, the one or more messages may include one or more RRC messages, one or more MAC-CEs, one or more downlink control information (DCI) messages, one or more sidelink control information (SCI) messages, or any combination thereof.

The second communication node (or, by way of example, any communication node of the set of one or more communication nodes that received a request for network data from the first communication node) may transmit information indicative of one or more measurements by the second communication node and/or meta data via the third signaling. For example, the second communication node may receive the request from the first communication node, perform one or more measurements requested by the first communication node, collect meta data requested by the first communication node, package the measurement(s) and/or the meta data into one or more messages, and transmit the collected and packaged network data to the first communication node via the one or more messages. The one or more messages may include one or more messages associated with a 3GPP signaling protocol, an 802.11 signaling protocol, or any other wireless signaling protocol. By way of example, the one or more messages may include one or more RRC messages, one or more MAC-CEs, one or more uplink control information (UCI) messages, one or more SCI messages, or any combination thereof.

The first communication node may transmit the received network data (e.g., the one or more measurements and/or the meta data) to the digital twin server via the fourth signaling. For example, the first communication node may receive the network data from the second communication node (or, by way of example, a set of one or more other communication nodes) and may transmit the network data (e.g., the measurements and/or the meta data) to the digital twin server via one or more messages. In examples in which the first communication node receives network data from each communication node of a set of multiple communication nodes, the first communication node may package the network data received from the multiple communication nodes into one or multiple messages and transmit the one or multiple messages to the digital twin server. The first communication node may transmit the network data to the digital twin server via wired (e.g., in accordance with a USB, such as USB-C, signaling protocol or any other wired signaling protocol) or wireless signaling (e.g., in accordance with a 3GPP signaling protocol, an 802.11 signaling protocol, or any other wireless signaling protocol). The digital twin server, in accordance with receiving the network data (as requested and conditioned by the digital twin via the first signaling), may apply the network data to a digital twin as part of a creation or refinement of the digital twin, which may enable the digital twin to more accurately model (e.g., represent) the physical world (by filling in “holes” and by closed loop digital twin calibration). In other words, the digital twin server may use the network data to create or refine the digital twin.

In some implementations, the digital twin server, the first communication node, or the second communication node (or any combination thereof) may use one or more measurements (e.g., RF measurements, such as channel quality measurements) to support material identification, which may further increase a performance of the digital twin. For example, RF measurements from one or more communication nodes may be used to determine material type or material properties (e.g., to identify glass (including type of glass, such as low-E glass vs. normal/high-E glass), plastic, marble, stone, concrete, etc.) within the geographic area, which the digital twin server may further use to create or refine the digital twin to build a more accurate representation of the geographic area. In some implementations, the digital twin server may generate an original digital twin by mapping all surfaces to a default material (e.g., concrete) and may generate a refined or updated digital twin by further identifying surface materials using computer vision and one or more RF measurements. In such implementations, the refined or updated digital twin may increase an accuracy associated with an average synchronization signal block (SSB) distribution from over-the-air (OTA) data across various potential node positions within the geographic area.

In some implementations, the digital twin server may communicate with one or more of various other types of devices or nodes (e.g., non-communication nodes). For example, the digital twin server may communicate (via one or more wired or wireless connections) with one or more devices or nodes to receive or obtain one or more updates such as weather, map service, or emergency warning service (e.g., via an earthquake and tsunami warning system (ETWS)). In some implementations, the digital twin server may trigger one or more measurements (by one or more communication nodes) in accordance with any one or more of such updates. In some examples, such updates may be associated with a geographic area associated with a digital twin. For example, the digital twin server may receive an update associated with a weather, a map service, or an emergency warning service from a device or node (which may not have wireless communication capabilities) and, depending on the update, may selectively transmit a request for network data from one or more communication nodes. A condition associated with from which communication nodes the network data is requested, and/or the type of requested network data, may depend on the one or more updates.

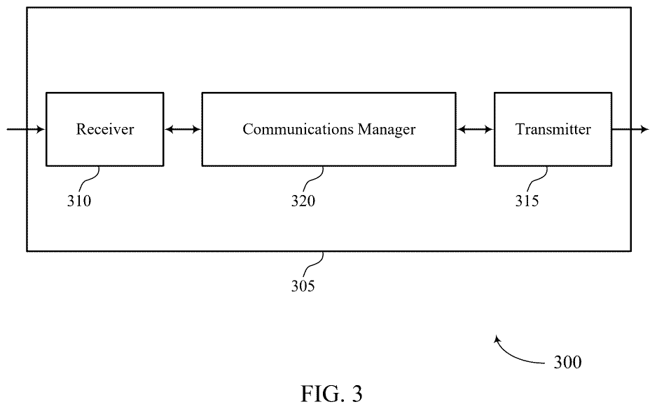

FIG. 3 shows a block diagram 300 of a device 305 that supports signaling between communication nodes to create or refine a digital twin in accordance with one or more aspects of the present disclosure. The device 305 may be an example of aspects of a UE 115, a network entity 105, or a digital twin server as described herein. The device 305 may include a receiver 310, a transmitter 315, and a communications manager 320 (which may be an example of or which may include a digital twin creation entity). The device 305, or one or more components of the device 305 (e.g., the receiver 310, the transmitter 315, the communications manager 320), may include at least one processor, which may be coupled with at least one memory, to, individually or collectively, support or enable the described techniques. Each of these components may be in communication with one another (e.g., via one or more buses).

The receiver 310 may provide a means for receiving information such as packets, user data, control information, or any combination thereof associated with various information channels (e.g., control channels, data channels, information channels related to signaling between communication nodes to create or refine a digital twin). Information may be passed on to other components of the device 305. The receiver 310 may utilize a single antenna or a set of multiple antennas.

The transmitter 315 may provide a means for transmitting signals generated by other components of the device 305. For example, the transmitter 315 may transmit information such as packets, user data, control information, or any combination thereof associated with various information channels (e.g., control channels, data channels, information channels related to signaling between communication nodes to create or refine a digital twin). In some examples, the transmitter 315 may be co-located with a receiver 310 in a transceiver module. The transmitter 315 may utilize a single antenna or a set of multiple antennas.

The communications manager 320, the receiver 310, the transmitter 315, or various combinations or components thereof may be examples of means for performing various aspects of signaling between communication nodes to create or refine a digital twin as described herein. For example, the communications manager 320, the receiver 310, the transmitter 315, or various combinations or components thereof may be capable of performing one or more of the functions described herein.

In some examples, the communications manager 320, the receiver 310, the transmitter 315, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 320, the receiver 310, the transmitter 315, or various combinations or components thereof may be implemented in code (e.g., as communications management software or firmware) executed by at least one processor (e.g., referred to as a processor-executable code). If implemented in code executed by at least one processor, the functions of the communications manager 320, the receiver 310, the transmitter 315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 320 may be configured to perform various operations (e.g., receiving, obtaining, monitoring, outputting, transmitting) using or otherwise in cooperation with the receiver 310, the transmitter 315, or both. For example, the communications manager 320 may receive information from the receiver 310, send information to the transmitter 315, or be integrated in combination with the receiver 310, the transmitter 315, or both to obtain information, output information, or perform various other operations as described herein.

The communications manager 320 may support wireless communication in accordance with examples as disclosed herein. For example, the communications manager 320 is capable of, configured to, or operable to support a means for transmitting, to a second communication node located within a geographic area associated with a digital twin, a request for network data. The communications manager 320 is capable of, configured to, or operable to support a means for receiving, from the second communication node, the network data in accordance with the request. The communications manager 320 is capable of, configured to, or operable to support a means for sending, to a server associated with the digital twin, the network data received from the second communication node.

Additionally, or alternatively, the communications manager 320 may support digital twin refinement in accordance with examples as disclosed herein. For example, the communications manager 320 is capable of, configured to, or operable to support a means for sending, to a first communication node that provides network coverage for a geographic area associated with the digital twin, a request for network data from one or more other communication nodes within the geographic area. The communications manager 320 is capable of, configured to, or operable to support a means for obtaining, from the first communication node, the network data in accordance with the request.

Additionally, or alternatively, the communications manager 320 may support wireless communication in accordance with examples as disclosed herein. For example, the communications manager 320 is capable of, configured to, or operable to support a means for receiving, from a second communication node, a request for network data in accordance with a digital twin being associated with a geographic area within which the first communication node is located. The communications manager 320 is capable of, configured to, or operable to support a means for transmitting, to the second communication node, the network data in accordance with the request.

By including or configuring the communications manager 320 in accordance with examples as described herein, the device 305 (e.g., at least one processor controlling or otherwise coupled with the receiver 310, the transmitter 315, the communications manager 320, or a combination thereof) may support techniques that facilitate creation or refinement of a more accurately representative digital twin associated with a geographic area.

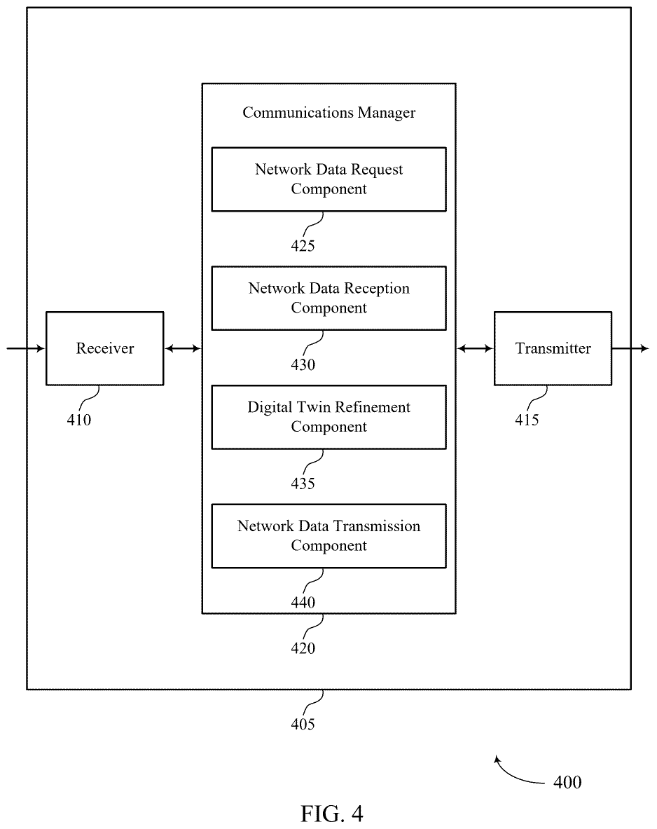

FIG. 4 shows a block diagram 400 of a device 405 that supports signaling between communication nodes to create or refine a digital twin in accordance with one or more aspects of the present disclosure. The device 405 may be an example of aspects of a device 305, a UE 115, a network entity 105, or a digital twin server as described herein. The device 405 may include a receiver 410, a transmitter 415, and a communications manager 420 (which may be an example of or which may include a digital twin creation entity). The device 405, or one or more components of the device 405 (e.g., the receiver 410, the transmitter 415, the communications manager 420), may include at least one processor, which may be coupled with at least one memory, to support the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to signaling between communication nodes to create or refine a digital twin). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to signaling between communication nodes to create or refine a digital twin). In some examples, the transmitter 415 may be co-located with a receiver 410 in a transceiver module. The transmitter 415 may utilize a single antenna or a set of multiple antennas.

The device 405, or various components thereof, may be an example of means for performing various aspects of signaling between communication nodes to create or refine a digital twin as described herein. For example, the communications manager 420 may include a network data request component 425, a network data reception component 430, a digital twin refinement component 435, a network data transmission component 440, or any combination thereof. The communications manager 420 may be an example of aspects of a communications manager 320 as described herein. In some examples, the communications manager 420, or various components thereof, may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. The network data request component 425 is capable of, configured to, or operable to support a means for transmitting, to a second communication node located within a geographic area associated with a digital twin, a request for network data. The network data reception component 430 is capable of, configured to, or operable to support a means for receiving, from the second communication node, the network data in accordance with the request. The digital twin refinement component 435 is capable of, configured to, or operable to support a means for sending, to a server associated with the digital twin, the network data received from the second communication node.

Additionally, or alternatively, the communications manager 420 may support digital twin refinement in accordance with examples as disclosed herein. The network data request component 425 is capable of, configured to, or operable to support a means for sending, to a first communication node that provides network coverage for a geographic area associated with the digital twin, a request for network data from one or more other communication nodes within the geographic area. The network data reception component 430 is capable of, configured to, or operable to support a means for obtaining, from the first communication node, the network data in accordance with the request.

Additionally, or alternatively, the communications manager 420 may support wireless communication in accordance with examples as disclosed herein. The network data reception component 430 is capable of, configured to, or operable to support a means for receiving, from a second communication node, a request for network data in accordance with a digital twin being associated with a geographic area within which the first communication node is located. The network data transmission component 440 is capable of, configured to, or operable to support a means for transmitting, to the second communication node, the network data in accordance with the request.

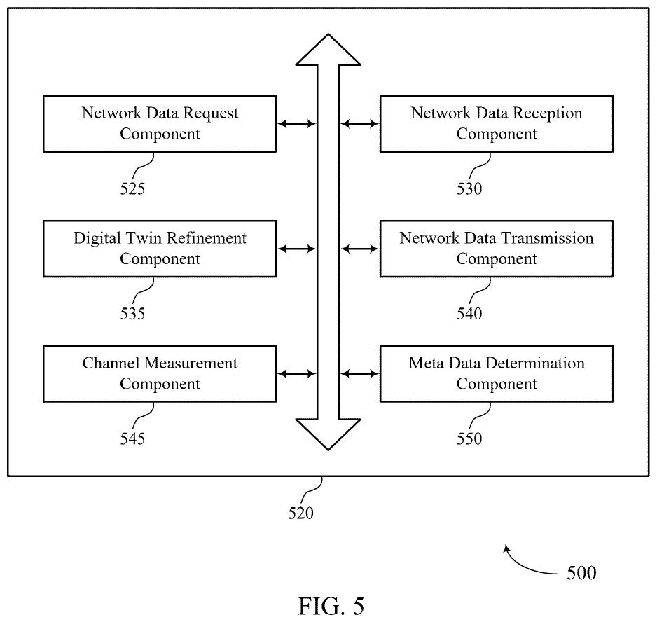

FIG. 5 shows a block diagram 500 of a communications manager 520 that supports signaling between communication nodes to create or refine a digital twin in accordance with one or more aspects of the present disclosure. The communications manager 520 may be an example of aspects of a communications manager 320, a communications manager 420, or both, as described herein. The communications manager 520 (which may be an example of or include a digital twin creation entity), or various components thereof, may be an example of means for performing various aspects of signaling between communication nodes to create or refine a digital twin as described herein. For example, the communications manager 520 may include a network data request component 525, a network data reception component 530, a digital twin refinement component 535, a network data transmission component 540, a channel measurement component 545, a meta data determination component 550, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 520 may support wireless communication in accordance with examples as disclosed herein. The network data request component 525 is capable of, configured to, or operable to support a means for transmitting, to a second communication node located within a geographic area associated with a digital twin, a request for network data. The network data reception component 530 is capable of, configured to, or operable to support a means for receiving, from the second communication node, the network data in accordance with the request. The digital twin refinement component 535 is capable of, configured to, or operable to support a means for sending, to a server associated with the digital twin, the network data received from the second communication node.

In some examples, the digital twin refinement component 535 is capable of, configured to, or operable to support a means for obtaining, from the server associated with the digital twin, an indication of a type of one or more channel quality measurements requested from one or more communication nodes or of a condition associated with the digital twin, where the request for the network data is transmitted in accordance with the indication.

In some examples, the network data includes one or more channel quality measurements by the second communication node or meta data associated with the second communication node.

In some examples, the request for the network data is transmitted in accordance with a condition associated with the digital twin being satisfied by the second communication node. In some examples, the condition associated with the digital twin is satisfied based on one or more of a location of the second communication node being within a target area within the geographic area, a modem type of the second communication node, an original equipment manufacturer of the second communication node, or an actual channel quality measurement by the second communication node differing by at least a threshold amount relative to an expected channel quality measurement associated with the digital twin.

In some examples, the network data request component 525 is capable of, configured to, or operable to support a means for transmitting, to a third communication node located within the geographic area associated with the digital twin, a second request for second network data. In some examples, the network data reception component 530 is capable of, configured to, or operable to support a means for receiving, from the third communication node, the second network data in accordance with the second request. In some examples, the digital twin refinement component 535 is capable of, configured to, or operable to support a means for sending, to the server associated with the digital twin, the second network data received from the third communication node.

In some examples, the digital twin refinement component 535 is capable of, configured to, or operable to support a means for packaging the network data received from the second communication node and the second network data received from the third communication node within one or more messages, where the network data and the second network data are sent to the server via the one or more messages.

In some examples, the second request for the second network data is transmitted in accordance with a condition associated with the digital twin being satisfied by the third communication node.

Additionally, or alternatively, the communications manager 520 may support digital twin refinement in accordance with examples as disclosed herein. In some examples, the network data request component 525 is capable of, configured to, or operable to support a means for sending, to a first communication node that provides network coverage for a geographic area associated with the digital twin, a request for network data from one or more other communication nodes within the geographic area. In some examples, the network data reception component 530 is capable of, configured to, or operable to support a means for obtaining, from the first communication node, the network data in accordance with the request.

In some examples, the digital twin refinement component 535 is capable of, configured to, or operable to support a means for using the network data to create or refine the digital twin in accordance with reception of the network data from the first communication node.

In some examples, the network data includes a respective set of one or more channel quality measurements by each communication node of the one or more other communication nodes or respective meta data associated with each communication node of the one or more other communication nodes.

In some examples, the request for the network data indicates a type of one or more channel quality measurements requested from the one or more other communication nodes or indicates a condition associated with the digital twin.

In some examples, the request for the network data is sent in accordance with a condition associated with the digital twin being satisfied by the one or more other communication nodes. In some examples, the condition associated with the digital twin is based on one or more of a target area within the geographic area, a modem type, an original equipment manufacturer, or a threshold difference relative to an expected channel quality measurement associated with the digital twin.

Additionally, or alternatively, the communications manager 520 may support wireless communication in accordance with examples as disclosed herein. In some examples, the network data reception component 530 is capable of, configured to, or operable to support a means for receiving, from a second communication node, a request for network data in accordance with a digital twin being associated with a geographic area within which the first communication node is located. The network data transmission component 540 is capable of, configured to, or operable to support a means for transmitting, to the second communication node, the network data in accordance with the request.

In some examples, the network data includes one or more channel quality measurements by the first communication node or meta data associated with the first communication node.

In some examples, the channel measurement component 545 is capable of, configured to, or operable to support a means for performing the one or more channel quality measurements in accordance with reception of the request. In some examples, the meta data determination component 550 is capable of, configured to, or operable to support a means for determining the meta data in accordance with performance of the one or more channel quality measurements.

In some examples, the request for the network data is received in accordance with a condition associated with the digital twin being satisfied by the first communication node. In some examples, the condition associated with the digital twin is satisfied based on one or more of a location of the first communication node being within a target area within the geographic area, a modem type of the first communication node, an original equipment manufacturer of the first communication node, or an actual channel quality measurement by the first communication node differing by at least a threshold amount relative to an expected channel quality measurement associated with the digital twin.

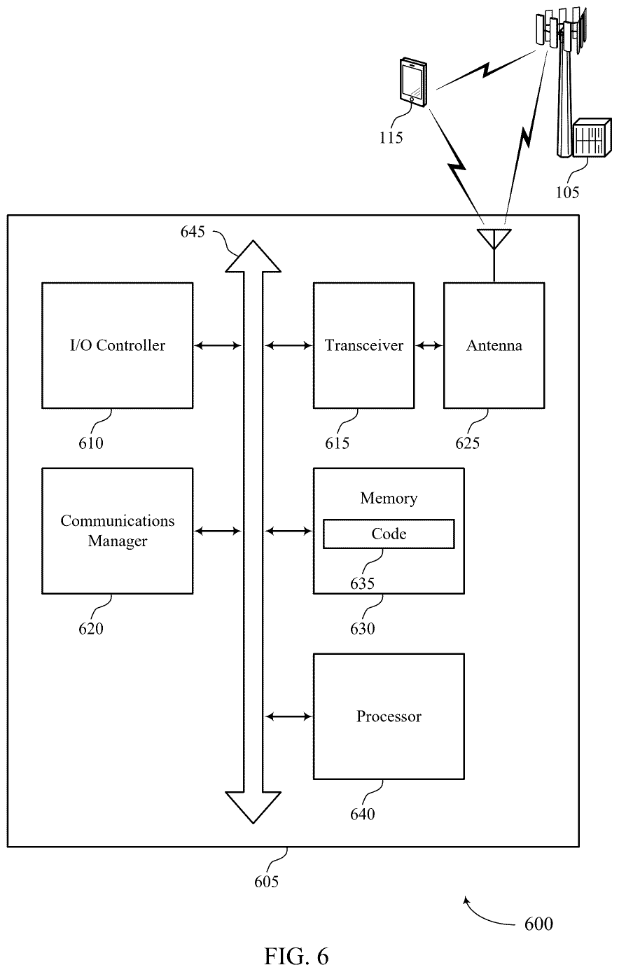

FIG. 6 shows a diagram of a system 600 including a device 605 that supports signaling between communication nodes to create or refine a digital twin in accordance with one or more aspects of the present disclosure. The device 605 may be an example of or include components of a device 305, a device 405, or a UE 115 as described herein. The device 605 may communicate (e.g., wirelessly) with one or more other devices (e.g., network entities 105, UEs 115, or a combination thereof). The device 605 may include components for bi-directional voice and data communications including components for transmitting and receiving communications, such as a communications manager 620 (which may be an example of or include a digital twin creation entity), an input/output (I/O) controller, such as an I/O controller 610, a transceiver 615, one or more antennas 625, at least one memory 630, code 635, and at least one processor 640. These components may be in electronic communication or otherwise coupled (e.g., operatively, communicatively, functionally, electronically, electrically) via one or more buses (e.g., a bus 645).

The I/O controller 610 may manage input and output signals for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. Additionally, or alternatively, the I/O controller 610 may represent or interact with a modem, a keyboard, a mouse, a touchscreen, or a similar device. In some cases, the I/O controller 610 may be implemented as part of one or more processors, such as the at least one processor 640. In some cases, a user may interact with the device 605 via the I/O controller 610 or via hardware components controlled by the I/O controller 610.

In some cases, the device 605 may include a single antenna. However, in some other cases, the device 605 may have more than one antenna, which may be capable of concurrently transmitting or receiving multiple wireless transmissions. The transceiver 615 may communicate bi-directionally via the one or more antennas 625 using wired or wireless links as described herein. For example, the transceiver 615 may represent a wireless transceiver and may communicate bi-directionally with another wireless transceiver. The transceiver 615 may also include a modem to modulate the packets, to provide the modulated packets to one or more antennas 625 for transmission, and to demodulate packets received from the one or more antennas 625. The transceiver 615, or the transceiver 615 and one or more antennas 625, may be an example of a transmitter 315, a transmitter 415, a receiver 310, a receiver 410, or any combination thereof or component thereof, as described herein.

The at least one memory 630 may include random access memory (RAM) and read-only memory (ROM). The at least one memory 630 may store computer-readable, computer-executable, or processor-executable code, such as the code 635. The code 635 may include instructions that, when executed by the at least one processor 640, cause the device 605 to perform various functions described herein. The code 635 may be stored in a non-transitory computer-readable medium such as system memory or another type of memory. In some cases, the code 635 may not be directly executable by the at least one processor 640 but may cause a computer (e.g., when compiled and executed) to perform functions described herein. In some cases, the at least one memory 630 may include, among other things, a basic I/O system (BIOS) which may control basic hardware or software operation such as the interaction with peripheral components or devices.

The at least one processor 640 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 640 may be configured to operate a memory array using a memory controller. In some other cases, a memory controller may be integrated into the at least one processor 640. The at least one processor 640 may be configured to execute computer-readable instructions stored in a memory (e.g., the at least one memory 630) to cause the device 605 to perform various functions (e.g., functions or tasks supporting signaling between communication nodes to create or refine a digital twin). For example, the device 605 or a component of the device 605 may include at least one processor 640 and at least one memory 630 coupled with or to the at least one processor 640, the at least one processor 640 and the at least one memory 630 configured to perform various functions described herein.

In some examples, the at least one processor 640 may include multiple processors and the at least one memory 630 may include multiple memories. One or more of the multiple processors may be coupled with one or more of the multiple memories, which may, individually or collectively, be configured to perform various functions described herein. In some examples, the at least one processor 640 may be a component of a processing system, which may refer to a system (such as a series) of machines, circuitry (including, for example, one or both of processor circuitry (which may include the at least one processor 640) and memory circuitry (which may include the at least one memory 630)), or components, that receives or obtains inputs and processes the inputs to produce, generate, or obtain a set of outputs. The processing system may be configured to perform one or more of the functions described herein. For example, the at least one processor 640 or a processing system including the at least one processor 640 may be configured to, configurable to, or operable to cause the device 605 to perform one or more of the functions described herein. Further, as described herein, being “configured to,” being “configurable to,” and being “operable to” may be used interchangeably and may be associated with a capability, when executing code 635 (e.g., processor-executable code) stored in the at least one memory 630 or otherwise, to perform one or more of the functions described herein.

The communications manager 620 may support wireless communication in accordance with examples as disclosed herein. For example, the communications manager 620 is capable of, configured to, or operable to support a means for transmitting, to a second communication node located within a geographic area associated with a digital twin, a request for network data. The communications manager 620 is capable of, configured to, or operable to support a means for receiving, from the second communication node, the network data in accordance with the request. The communications manager 620 is capable of, configured to, or operable to support a means for sending, to a server associated with the digital twin, the network data received from the second communication node.

Additionally, or alternatively, the communications manager 620 may support digital twin refinement in accordance with examples as disclosed herein. For example, the communications manager 620 is capable of, configured to, or operable to support a means for sending, to a first communication node that provides network coverage for a geographic area associated with the digital twin, a request for network data from one or more other communication nodes within the geographic area. The communications manager 620 is capable of, configured to, or operable to support a means for obtaining, from the first communication node, the network data in accordance with the request.

Additionally, or alternatively, the communications manager 620 may support wireless communication in accordance with examples as disclosed herein. For example, the communications manager 620 is capable of, configured to, or operable to support a means for receiving, from a second communication node, a request for network data in accordance with a digital twin being associated with a geographic area within which the first communication node is located. The communications manager 620 is capable of, configured to, or operable to support a means for transmitting, to the second communication node, the network data in accordance with the request.

By including or configuring the communications manager 620 in accordance with examples as described herein, the device 605 may support techniques that facilitate creation or refinement of a more accurately representative digital twin associated with a geographic area.

In some examples, the communications manager 620 may be configured to perform various operations (e.g., receiving, monitoring, transmitting) using or otherwise in cooperation with the transceiver 615, the one or more antennas 625, or any combination thereof. Although the communications manager 620 is illustrated as a separate component, in some examples, one or more functions described with reference to the communications manager 620 may be supported by or performed by the at least one processor 640, the at least one memory 630, the code 635, or any combination thereof. For example, the code 635 may include instructions executable by the at least one processor 640 to cause the device 605 to perform various aspects of signaling between communication nodes to create or refine a digital twin as described herein, or the at least one processor 640 and the at least one memory 630 may be otherwise configured to, individually or collectively, perform or support such operations.

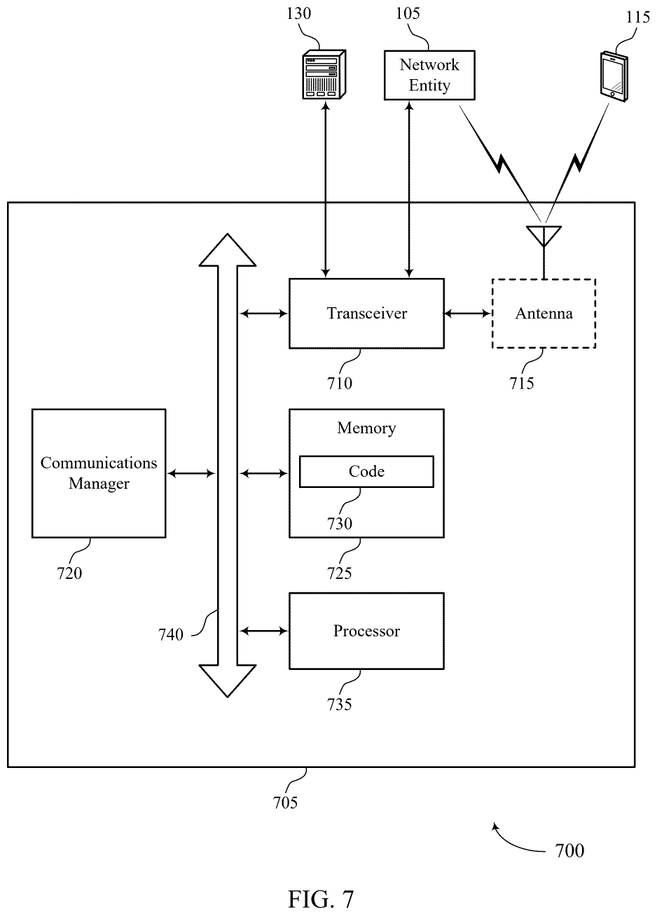

FIG. 7 shows a diagram of a system 700 including a device 705 that supports signaling between communication nodes to create or refine a digital twin in accordance with one or more aspects of the present disclosure. The device 705 may be an example of or include components of a device 305, a device 405, or a network entity 105 as described herein. The device 705 may communicate with other network devices or network equipment such as one or more of the network entities 105, UEs 115, or any combination thereof. The communications may include communications over one or more wired interfaces, over one or more wireless interfaces, or any combination thereof. The device 705 may include components that support outputting and obtaining communications, such as a communications manager 720, a transceiver 710, one or more antennas 715, at least one memory 725, code 730, and at least one processor 735. These components may be in electronic communication or otherwise coupled (e.g., operatively, communicatively, functionally, electronically, electrically) via one or more buses (e.g., a bus 740).

The transceiver 710 may support bi-directional communications via wired links, wireless links, or both as described herein. In some examples, the transceiver 710 may include a wired transceiver and may communicate bi-directionally with another wired transceiver. Additionally, or alternatively, in some examples, the transceiver 710 may include a wireless transceiver and may communicate bi-directionally with another wireless transceiver. In some examples, the device 705 may include one or more antennas 715, which may be capable of transmitting or receiving wireless transmissions (e.g., concurrently). The transceiver 710 may also include a modem to modulate signals, to provide the modulated signals for transmission (e.g., by one or more antennas 715, by a wired transmitter), to receive modulated signals (e.g., from one or more antennas 715, from a wired receiver), and to demodulate signals. In some implementations, the transceiver 710 may include one or more interfaces, such as one or more interfaces coupled with the one or more antennas 715 that are configured to support various receiving or obtaining operations, or one or more interfaces coupled with the one or more antennas 715 that are configured to support various transmitting or outputting operations, or a combination thereof. In some implementations, the transceiver 710 may include or be configured for coupling with one or more processors or one or more memory components that are operable to perform or support operations based on received or obtained information or signals, or to generate information or other signals for transmission or other outputting, or any combination thereof. In some implementations, the transceiver 710, or the transceiver 710 and the one or more antennas 715, or the transceiver 710 and the one or more antennas 715 and one or more processors or one or more memory components (e.g., the at least one processor 735, the at least one memory 725, or both), may be included in a chip or chip assembly that is installed in the device 705. In some examples, the transceiver 710 may be operable to support communications via one or more communications links (e.g., communication link(s) 125, backhaul communication link(s) 120, a midhaul communication link 162, a fronthaul communication link 168).

The at least one memory 725 may include RAM, ROM, or any combination thereof. The at least one memory 725 may store computer-readable, computer-executable, or processor-executable code, such as the code 730. The code 730 may include instructions that, when executed by one or more of the at least one processor 735, cause the device 705 to perform various functions described herein. The code 730 may be stored in a non-transitory computer-readable medium such as system memory or another type of memory. In some cases, the code 730 may not be directly executable by a processor of the at least one processor 735 but may cause a computer (e.g., when compiled and executed) to perform functions described herein. In some cases, the at least one memory 725 may include, among other things, a BIOS which may control basic hardware or software operation such as the interaction with peripheral components or devices. In some examples, the at least one processor 735 may include multiple processors and the at least one memory 725 may include multiple memories. One or more of the multiple processors may be coupled with one or more of the multiple memories which may, individually or collectively, be configured to perform various functions herein (for example, as part of a processing system).

The at least one processor 735 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 735 may be configured to operate a memory array using a memory controller. In some other cases, a memory controller may be integrated into one or more of the at least one processor 735. The at least one processor 735 may be configured to execute computer-readable instructions stored in a memory (e.g., one or more of the at least one memory 725) to cause the device 705 to perform various functions (e.g., functions or tasks supporting signaling between communication nodes to create or refine a digital twin). For example, the device 705 or a component of the device 705 may include at least one processor 735 and at least one memory 725 coupled with one or more of the at least one processor 735, the at least one processor 735 and the at least one memory 725 configured to perform various functions described herein. The at least one processor 735 may be an example of a cloud-computing platform (e.g., one or more physical nodes and supporting software such as operating systems, virtual machines, or container instances) that may host the functions (e.g., by executing code 730) to perform the functions of the device 705. The at least one processor 735 may be any one or more suitable processors capable of executing scripts or instructions of one or more software programs stored in the device 705 (such as within one or more of the at least one memory 725).

In some examples, the at least one processor 735 may include multiple processors and the at least one memory 725 may include multiple memories. One or more of the multiple processors may be coupled with one or more of the multiple memories, which may, individually or collectively, be configured to perform various functions herein. In some examples, the at least one processor 735 may be a component of a processing system, which may refer to a system (such as a series) of machines, circuitry (including, for example, one or both of processor circuitry (which may include the at least one processor 735) and memory circuitry (which may include the at least one memory 725)), or components, that receives or obtains inputs and processes the inputs to produce, generate, or obtain a set of outputs. The processing system may be configured to perform one or more of the functions described herein. For example, the at least one processor 735 or a processing system including the at least one processor 735 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 725 or otherwise, to perform one or more of the functions described herein.

In some examples, a bus 740 may support communications of (e.g., within) a protocol layer of a protocol stack. In some examples, a bus 740 may support communications associated with a logical channel of a protocol stack (e.g., between protocol layers of a protocol stack), which may include communications performed within a component of the device 705, or between different components of the device 705 that may be co-located or located in different locations (e.g., where the device 705 may refer to a system in which one or more of the communications manager 720, the transceiver 710, the at least one memory 725, the code 730, and the at least one processor 735 may be located in one of the different components or divided between different components).

In some examples, the communications manager 720 may manage aspects of communications with a core network 130 (e.g., via one or more wired or wireless backhaul links). For example, the communications manager 720 may manage the transfer of data communications for client devices, such as one or more UEs 115. In some examples, the communications manager 720 may manage communications with one or more other network entities 105, and may include a controller or scheduler for controlling communications with UEs 115 (e.g., in cooperation with the one or more other network devices). In some examples, the communications manager 720 may support an X2 interface within an LTE/LTE-A wireless communications network technology to provide communication between network entities 105.

The communications manager 720 may support wireless communication in accordance with examples as disclosed herein. For example, the communications manager 720 is capable of, configured to, or operable to support a means for transmitting, to a second communication node located within a geographic area associated with a digital twin, a request for network data. The communications manager 720 is capable of, configured to, or operable to support a means for receiving, from the second communication node, the network data in accordance with the request. The communications manager 720 is capable of, configured to, or operable to support a means for sending, to a server associated with the digital twin, the network data received from the second communication node.

Additionally, or alternatively, the communications manager 720 may support digital twin refinement in accordance with examples as disclosed herein. For example, the communications manager 720 is capable of, configured to, or operable to support a means for sending, to a first communication node that provides network coverage for a geographic area associated with the digital twin, a request for network data from one or more other communication nodes within the geographic area. The communications manager 720 is capable of, configured to, or operable to support a means for obtaining, from the first communication node, the network data in accordance with the request.

Additionally, or alternatively, the communications manager 720 may support wireless communication in accordance with examples as disclosed herein. For example, the communications manager 720 is capable of, configured to, or operable to support a means for receiving, from a second communication node, a request for network data in accordance with a digital twin being associated with a geographic area within which the first communication node is located. The communications manager 720 is capable of, configured to, or operable to support a means for transmitting, to the second communication node, the network data in accordance with the request.

By including or configuring the communications manager 720 in accordance with examples as described herein, the device 705 may support techniques that facilitate creation or refinement of a more accurately representative digital twin associated with a geographic area.

In some examples, the communications manager 720 may be configured to perform various operations (e.g., receiving, obtaining, monitoring, outputting, transmitting) using or otherwise in cooperation with the transceiver 710, the one or more antennas 715 (e.g., where applicable), or any combination thereof. Although the communications manager 720 is illustrated as a separate component, in some examples, one or more functions described with reference to the communications manager 720 may be supported by or performed by the transceiver 710, one or more of the at least one processor 735, one or more of the at least one memory 725, the code 730, or any combination thereof (for example, by a processing system including at least a portion of the at least one processor 735, the at least one memory 725, the code 730, or any combination thereof). For example, the code 730 may include instructions executable by one or more of the at least one processor 735 to cause the device 705 to perform various aspects of signaling between communication nodes to create or refine a digital twin as described herein, or the at least one processor 735 and the at least one memory 725 may be otherwise configured to, individually or collectively, perform or support such operations.

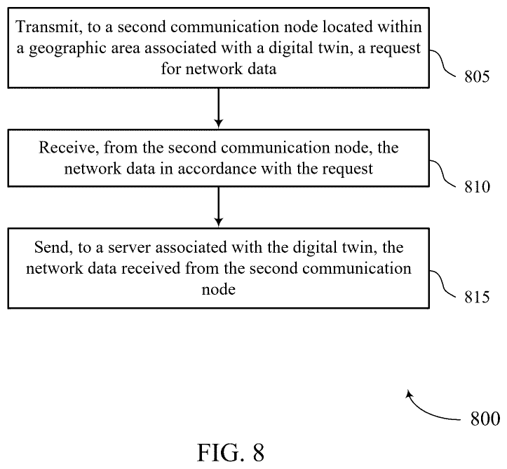

FIG. 8 shows a flowchart illustrating a method 800 that supports signaling between communication nodes to create or refine a digital twin in accordance with one or more aspects of the present disclosure. The operations of the method 800 may be implemented by a UE or a network entity or its components as described herein. For example, the operations of the method 800 may be performed by a UE 115 or a network entity as described with reference to FIGS. 1 through 7. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 805, the method may include transmitting, to a second communication node located within a geographic area associated with a digital twin, a request for network data. The operations of 805 may be performed in accordance with examples as disclosed herein. In some examples, aspects of the operations of 805 may be performed by a network data request component 525 as described with reference to FIG. 5.

At 810, the method may include receiving, from the second communication node, the network data in accordance with the request. The operations of 810 may be performed in accordance with examples as disclosed herein. In some examples, aspects of the operations of 810 may be performed by a network data reception component 530 as described with reference to FIG. 5.

At 815, the method may include sending, to a server associated with the digital twin, the network data received from the second communication node. The operations of 815 may be performed in accordance with examples as disclosed herein. In some examples, aspects of the operations of 815 may be performed by a digital twin refinement component 535 as described with reference to FIG. 5.

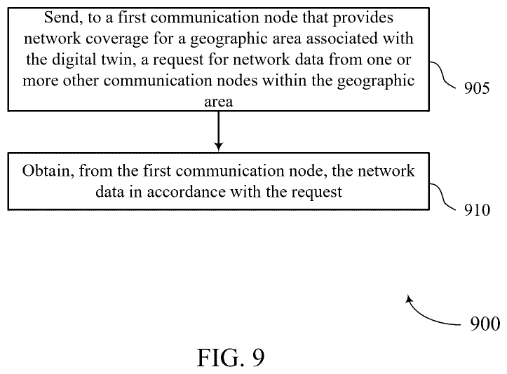

FIG. 9 shows a flowchart illustrating a method 900 that supports signaling between communication nodes to create or refine a digital twin in accordance with one or more aspects of the present disclosure. The operations of the method 900 may be implemented by a UE or a network entity or its components as described herein. For example, the operations of the method 900 may be performed by a UE 115 or a network entity as described with reference to FIGS. 1 through 7. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 905, the method may include sending, to a first communication node that provides network coverage for a geographic area associated with the digital twin, a request for network data from one or more other communication nodes within the geographic area. The operations of 905 may be performed in accordance with examples as disclosed herein. In some examples, aspects of the operations of 905 may be performed by a network data request component 525 as described with reference to FIG. 5.

At 910, the method may include obtaining, from the first communication node, the network data in accordance with the request. The operations of 910 may be performed in accordance with examples as disclosed herein. In some examples, aspects of the operations of 910 may be performed by a network data reception component 530 as described with reference to FIG. 5.

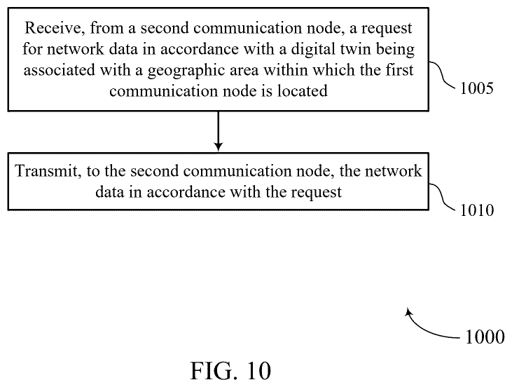

FIG. 10 shows a flowchart illustrating a method 1000 that supports signaling between communication nodes to create or refine a digital twin in accordance with one or more aspects of the present disclosure. The operations of the method 1000 may be implemented by a UE or a network entity or its components as described herein. For example, the operations of the method 1000 may be performed by a UE 115 or a network entity as described with reference to FIGS. 1 through 7. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1005, the method may include receiving, from a second communication node, a request for network data in accordance with a digital twin being associated with a geographic area within which the first communication node is located. The operations of 1005 may be performed in accordance with examples as disclosed herein. In some examples, aspects of the operations of 1005 may be performed by a network data reception component 530 as described with reference to FIG. 5.

At 1010, the method may include transmitting, to the second communication node, the network data in accordance with the request. The operations of 1010 may be performed in accordance with examples as disclosed herein. In some examples, aspects of the operations of 1010 may be performed by a network data transmission component 540 as described with reference to FIG. 5.

The following provides an overview of aspects of the present disclosure:
Aspect 1: A method for wireless communication at a first communication node, comprising: transmitting, to a second communication node located within a geographic area associated with a digital twin, a request for network data; receiving, from the second communication node, the network data in accordance with the request; and sending, to a server associated with the digital twin, the network data received from the second communication node.
Aspect 2: The method of aspect 1, further comprising: obtaining, from the server associated with the digital twin, an indication of a type of one or more channel quality measurements requested from one or more communication nodes or of a condition associated with the digital twin, wherein the request for the network data is transmitted in accordance with the indication.
Aspect 3: The method of any of aspects 1 through 2, wherein the network data comprises one or more channel quality measurements by the second communication node or meta data associated with the second communication node.
Aspect 4: The method of any of aspects 1 through 3, wherein the request for the network data is transmitted in accordance with a condition associated with the digital twin being satisfied by the second communication node, and the condition associated with the digital twin is satisfied based at least in part on one or more of a location of the second communication node being within a target area within the geographic area, a modem type of the second communication node, an original equipment manufacturer of the second communication node, or an actual channel quality measurement by the second communication node differing by at least a threshold amount relative to an expected channel quality measurement associated with the digital twin.
Aspect 5: The method of any of aspects 1 through 4, further comprising: transmitting, to a third communication node located within the geographic area associated with the digital twin, a second request for second network data; receiving, from the third communication node, the second network data in accordance with the second request; and sending, to the server associated with the digital twin, the second network data received from the third communication node.
Aspect 6: The method of aspect 5, further comprising: packaging the network data received from the second communication node and the second network data received from the third communication node within one or more messages, wherein the network data and the second network data are sent to the server via the one or more messages.
Aspect 7: The method of any of aspects 5 through 6, wherein the second request for the second network data is transmitted in accordance with a condition associated with the digital twin being satisfied by the third communication node.
Aspect 8: A method for digital twin refinement at a server associated with a digital twin, comprising: sending, to a first communication node that provides network coverage for a geographic area associated with the digital twin, a request for network data from one or more other communication nodes within the geographic area; and obtaining, from the first communication node, the network data in accordance with the request.
Aspect 9: The method of aspect 8, further comprising: using the network data to create or refine the digital twin in accordance with reception of the network data from the first communication node.
Aspect 10: The method of any of aspects 8 through 9, wherein the network data comprises a respective set of one or more channel quality measurements by each communication node of the one or more other communication nodes or respective meta data associated with each communication node of the one or more other communication nodes.
Aspect 11: The method of any of aspects 8 through 10, wherein the request for the network data indicates a type of one or more channel quality measurements requested from the one or more other communication nodes or indicates a condition associated with the digital twin.
Aspect 12: The method of any of aspects 8 through 11, wherein the request for the network data is sent in accordance with a condition associated with the digital twin being satisfied by the one or more other communication nodes, and the condition associated with the digital twin is based at least in part on one or more of a target area within the geographic area, a modem type, an original equipment manufacturer, or a threshold difference relative to an expected channel quality measurement associated with the digital twin.
Aspect 13: A method for wireless communication at a first communication node, comprising: receiving, from a second communication node, a request for network data in accordance with a digital twin being associated with a geographic area within which the first communication node is located; and transmitting, to the second communication node, the network data in accordance with the request.
Aspect 14: The method of aspect 13, wherein the network data comprises one or more channel quality measurements by the first communication node or meta data associated with the first communication node.
Aspect 15: The method of aspect 14, further comprising: performing the one or more channel quality measurements in accordance with reception of the request; and determining the meta data in accordance with performance of the one or more channel quality measurements.
Aspect 16: The method of any of aspects 13 through 15, wherein the request for the network data is received in accordance with a condition associated with the digital twin being satisfied by the first communication node, and the condition associated with the digital twin is satisfied based at least in part on one or more of a location of the first communication node being within a target area within the geographic area, a modem type of the first communication node, an original equipment manufacturer of the first communication node, or an actual channel quality measurement by the first communication node differing by at least a threshold amount relative to an expected channel quality measurement associated with the digital twin.
Aspect 17: A first communication node for wireless communication, comprising one or more memories storing processor-executable code, and one or more processors coupled with the one or more memories and individually or collectively operable to execute the code to cause the first communication node to perform a method of any of aspects 1 through 7.
Aspect 18: A first communication node for wireless communication, comprising at least one means for performing a method of any of aspects 1 through 7.
Aspect 19: A non-transitory computer-readable medium storing code for wireless communication, the code comprising instructions executable by one or more processors to perform a method of any of aspects 1 through 7.
Aspect 20: A server associated with a digital twin for digital twin refinement, comprising one or more memories storing processor-executable code, and one or more processors coupled with the one or more memories and individually or collectively operable to execute the code to cause the server associated with a digital twin to perform a method of any of aspects 8 through 12.
Aspect 21: A server associated with a digital twin for digital twin refinement, comprising at least one means for performing a method of any of aspects 8 through 12.
Aspect 22: A non-transitory computer-readable medium storing code for digital twin refinement, the code comprising instructions executable by one or more processors to perform a method of any of aspects 8 through 12.
Aspect 23: A first communication node for wireless communication, comprising one or more memories storing processor-executable code, and one or more processors coupled with the one or more memories and individually or collectively operable to execute the code to cause the first communication node to perform a method of any of aspects 13 through 16.
Aspect 24: A first communication node for wireless communication, comprising at least one means for performing a method of any of aspects 13 through 16.
Aspect 25: A non-transitory computer-readable medium storing code for wireless communication, the code comprising instructions executable by one or more processors to perform a method of any of aspects 13 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first communication node, comprising:
one or more memories storing processor-executable code; and
one or more processors coupled with the one or more memories and individually or collectively operable to execute the code to cause the first communication node to:
transmit, to a second communication node located within a geographic area associated with a digital twin, a request for network data;
receive, from the second communication node, the network data in accordance with the request; and
send, to a server associated with the digital twin, the network data received from the second communication node.

2. The first communication node of claim 1, wherein the one or more processors are individually or collectively further operable to execute the code to cause the first communication node to:
obtain, from the server associated with the digital twin, an indication of a type of one or more channel quality measurements requested from one or more communication nodes or of a condition associated with the digital twin, wherein the request for the network data is transmitted in accordance with the indication.

3. The first communication node of claim 1, wherein the network data comprises one or more channel quality measurements by the second communication node or meta data associated with the second communication node.

4. The first communication node of claim 1, wherein:
the request for the network data is transmitted in accordance with a condition associated with the digital twin being satisfied by the second communication node.

5. The first communication node of claim 4, wherein the condition associated with the digital twin is satisfied based at least in part on one or more of a location of the second communication node being within a target area within the geographic area, a modem type of the second communication node, an original equipment manufacturer of the second communication node, or an actual channel quality measurement by the second communication node differing by at least a threshold amount relative to an expected channel quality measurement associated with the digital twin.

6. The first communication node of claim 1, wherein the one or more processors are individually or collectively further operable to execute the code to cause the first communication node to:
transmit, to a third communication node located within the geographic area associated with the digital twin, a second request for second network data;
receive, from the third communication node, the second network data in accordance with the second request; and
send, to the server associated with the digital twin, the second network data received from the third communication node.

7. The first communication node of claim 6, wherein the one or more processors are individually or collectively further operable to execute the code to cause the first communication node to:
package the network data received from the second communication node and the second network data received from the third communication node within one or more messages, wherein the network data and the second network data are sent to the server via the one or more messages.

8. The first communication node of claim 6, wherein the second request for the second network data is transmitted in accordance with a condition associated with the digital twin being satisfied by the third communication node.

9. A server associated with a digital twin, comprising:
one or more memories storing processor-executable code; and
one or more processors coupled with the one or more memories and individually or collectively operable to execute the code to cause the server associated with the digital twin to:
send, to a first communication node that provides network coverage for a geographic area associated with the digital twin, a request for network data from one or more other communication nodes within the geographic area; and
obtain, from the first communication node, the network data in accordance with the request.

10. The server associated with the digital twin of claim 9, wherein the one or more processors are individually or collectively further operable to execute the code to cause the server associated with the digital twin to:
use the network data to create or refine the digital twin in accordance with reception of the network data from the first communication node.

11. The server associated with the digital twin of claim 9, wherein the network data comprises a respective set of one or more channel quality measurements by each communication node of the one or more other communication nodes or respective meta data associated with each communication node of the one or more other communication nodes.

12. The server associated with the digital twin of claim 9, wherein the request for the network data indicates a type of one or more channel quality measurements requested from the one or more other communication nodes or indicates a condition associated with the digital twin.

13. The server associated with the digital twin of claim 9, wherein:
the request for the network data is sent in accordance with a condition associated with the digital twin being satisfied by the one or more other communication nodes.

14. The server associated with the digital twin of claim 13, wherein the condition associated with the digital twin is based at least in part on one or more of a target area within the geographic area, a modem type, an original equipment manufacturer, or a threshold difference relative to an expected channel quality measurement associated with the digital twin.

15. A first communication node, comprising:
one or more memories storing processor-executable code; and
one or more processors coupled with the one or more memories and individually or collectively operable to execute the code to cause the first communication node to:
receive, from a second communication node, a request for network data in accordance with a digital twin being associated with a geographic area within which the first communication node is located; and
transmit, to the second communication node, the network data in accordance with the request.

16. The first communication node of claim 15, wherein the network data comprises one or more channel quality measurements by the first communication node or meta data associated with the first communication node.

17. The first communication node of claim 16, wherein the one or more processors are individually or collectively further operable to execute the code to cause the first communication node to:
perform the one or more channel quality measurements in accordance with reception of the request; and
determine the meta data in accordance with performance of the one or more channel quality measurements.

18. The first communication node of claim 15, wherein:
the request for the network data is received in accordance with a condition associated with the digital twin being satisfied by the first communication node.

19. The first communication node of claim 18, wherein the condition associated with the digital twin is satisfied based at least in part on one or more of a location of the first communication node being within a target area within the geographic area, a modem type of the first communication node, or an original equipment manufacturer of the first communication node.

20. The first communication node of claim 18, wherein the condition associated with the digital twin is satisfied based at least in part on an actual channel quality measurement by the first communication node differing by at least a threshold amount relative to an expected channel quality measurement associated with the digital twin.
